(19) United States
(12) Patent Application Publication
(10) Pub. No.: US 2020/0139552 A1
(43) Pub. Date: May 7, 2020

(54) A METHOD FOR CONTROLLING A SURFACE

(71) Applicant: SAFRAN, PARIS (FR)

(72) Inventors: Samuel Louis Marcel Marie MAILLARD, MOISSY-CRAMAYEL (FR); Nicolas SIRE, LA GENETOUZE (FR); Benoît BAZIN, MOISSY-CRAMAYEL (FR); Grégory CHARRIER, LE POIRE SUR VIE (FR); Nicolas LECONTE, MOISSY-CRAMAYEL (FR)

(21) Appl. No.: 16/632,634

(22) PCT Filed: Jul. 23, 2018
(86) PCT No.: PCT/FR2018/051888

§ 371 Date: Jan. 21, 2020

(30) Foreign Application Priority Data
Jul. 24, 2017 (FR) 1757011

(51) Int. Cl. B25J 9/16; G06T 17/10

(52) U.S. Cl. CPC B25J 9/1697; G05B 2219/50391; G06T 17/10

(57) ABSTRACT

The invention relates to a method for controlling a surface (1) of interest of a part (2) by means of a camera (3) intended to be mounted on a robot (4), the camera (3) comprising a sensor and optics associated with an optical centre C, an angular aperture alpha and a depth of field PC and defining a sharpness volume (6), this method comprising the following operations: loading a three-dimensional virtual model of the surface (1); generating a three-dimensional virtual model of the volume of sharpness (6); paving the model of the surface (1) by means of a plurality of unit models of said three-dimensional virtual model of the volume of sharpness (6); for each position of said unit models (6), calculating the corresponding position, called the acquisition position, of the camera (3).

The present invention relates to the field of control and more particularly that of robotic control applications using a matrix optical sensor.

In the industry, it is known to embark cameras such as matrix optical sensors on robots. For many applications, it is necessary to know precisely the positions of the end effectors on the robots. In the case of an optical sensor, the position of the optical center of the camera serves as an optical reference for the robot.

An example of a common application is the control of a surface by thermography. On large parts, it is then necessary to make several acquisitions taken from different points of view using an infrared camera positioned on a robotic arm.

It is known to use matrix sensor inspection (e.g. in the infrared range) on composite parts, but mainly in the laboratory or in production on surfaces with a relatively simple geometry. Relatively simple geometry means the absence of curvatures or variations in relief at the surface.

The development of a method for controlling parts with complex geometry under industrial conditions requires the mastery of:
the area viewed in relation to the position and orientation of the matrix sensor embedded in an industrial robot,
the design of the robot trajectory respecting parameters influencing the control method.

The control of the viewing area is based on the precise positioning of the surface to be controlled at a given focusing distance between the surface and the optical center of the camera, and according to the depth of field of the camera.

The design of the robot trajectory is often carried out by teach-in or by experimental methods directly on the part to be controlled.

A method of controlling a surface of interest of a part by means of a camera to be mounted on a carrier robot, the camera comprising a sensor and optics associated with an optical center C, an angular aperture and a depth of field PC and defining a sharpness volume, the method comprising the following steps:
a) loading, in a virtual design environment, a three-dimensional virtual model of the surface of interest,
b) generating, in the virtual environment, a three-dimensional virtual model of the sharpness volume,
c) paving, in the virtual environment, the model of the surface of interest by means of a plurality of unit models of said three-dimensional virtual model of the volume of sharpness,
d) for each position of said unit models, calculating the corresponding position, called the acquisition position, of the camera.

This method allows to automatically define the crossing points for the robot, and consequently a predefined trajectory allowing it to successively move the camera at the acquisition points. The advantage of this method is that it can be carried out entirely in a virtual environment whereas the usual procedure consists of creating a trajectory by experimental learning directly on the part.

According to an example, the generation of the three-dimensional virtual model of the sharpness volume includes the operations of:
loading a three-dimensional model of the camera in the virtual environment,
generating a truncated pyramid of which:
   the top is optical center C,
   the angular aperture (or aperture cone) is that of the optics,
   two opposite sides define a first sharp plane PPN and a last sharp plane DPN, respectively, whose spacing corresponds to the depth of field PC of the optics.

This three-dimensional virtual model of the sharpness volume allows a simple and virtual representation of the optics parameters. It is directly related to the characteristics of the optics.

According to a preferred embodiment, the surface is located between the first sharp plane PPN and the last sharp plane DPN of each three-dimensional virtual model unit model of the sharpness volume.

This particular positioning is facilitated by the use of a three-dimensional virtual model of the volume of sharpness, and guarantees a sharp image with each acquisition during the surface control.

According to a particular feature, the generation of the three-dimensional virtual model of the sharpness volume comprises an operation of dividing said three-dimensional virtual model of the sharpness volume into a working area strictly included therein, and a peripheral overlapping area surrounding the working area. In the paving operation, the unit models of the three-dimensional virtual model of the volume of sharpness can be distributed so as to overlap two by two in said peripheral areas.

The generation of a work area makes it easier and faster to position unit volumes of the sharpness volume. As a matter of fact, the working area allows to discriminate an overlapping area in which the unit volumes overlap. This also gives the operator control over the desired level of overlapping.

According to a particular characteristic, the position of each unit model of the three-dimensional virtual model of the volume of sharpness is defined at least by the distance d between a singular point P of the three-dimensional virtual model of the surface to be controlled and its orthogonal projection on the first sharp plane PPN or on the last sharp plane DPN. This feature allows the operator to have control over the distance between the camera and the surface to be controlled. As a matter of fact, depending on the geometrical characteristics of the surface to be controlled, it may be relevant to put the distance d under a constraint. Controlling this distance makes it possible to master the spatial resolution of the images viewed.

According to another characteristic, the singular point P can be the barycentre of the three-dimensional virtual model of sharpness volume.

According to a particular feature, in the paving operation, the position of each unit model of the three-dimensional virtual model of the volume of sharpness is defined by the angle between an X-axis associated with the three-dimensional virtual model of the volume of sharpness and the normal N to the surface of interest at the point of intersection of the X-axis and the surface. The X-axis is, for example, an axis of symmetry of the three-dimensional virtual model of the sharpness volume. This feature allows the operator to have control over the angular orientation of each unit model of the three-dimensional virtual model of the sharpness volume. This makes it possible to control the orientation of the shooting on certain areas of the surface to be controlled.

The invention will be better understood and other details, characteristics and advantages of the invention will become readily apparent upon reading the following description, given by way of a non limiting example with reference to the appended drawings, wherein:

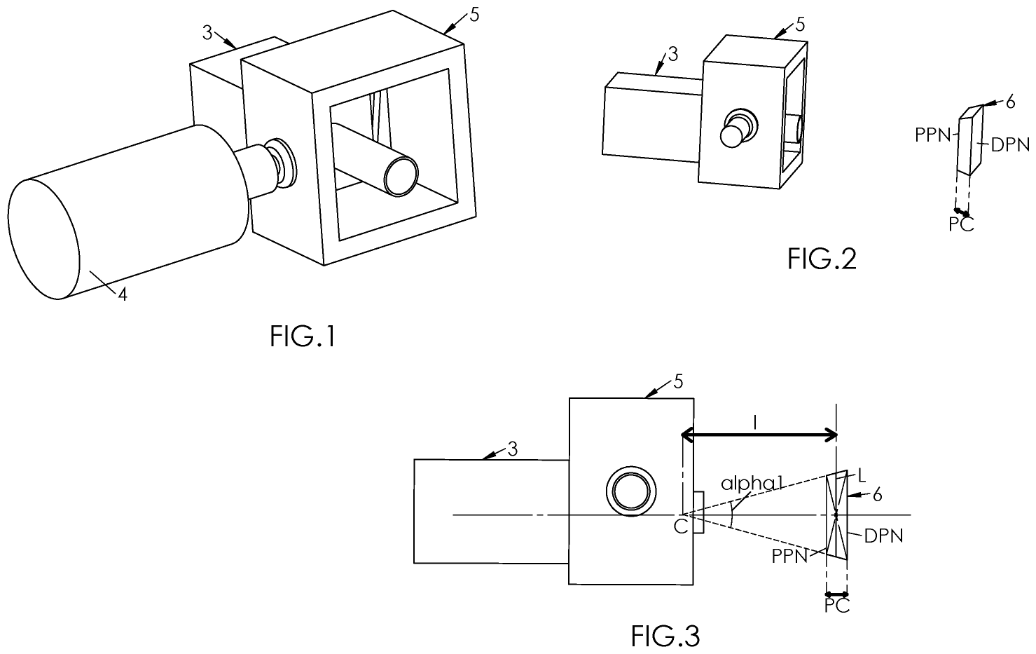

FIG. 1 is an illustration of a camera mounted on a carrier robot by means of tooling.

FIG. 2 is a perspective view of a camera mounted on a tool, and the associated volume of sharpness.

FIG. 3 is a side view of a tool-mounted camera and the associated volume of sharpness.

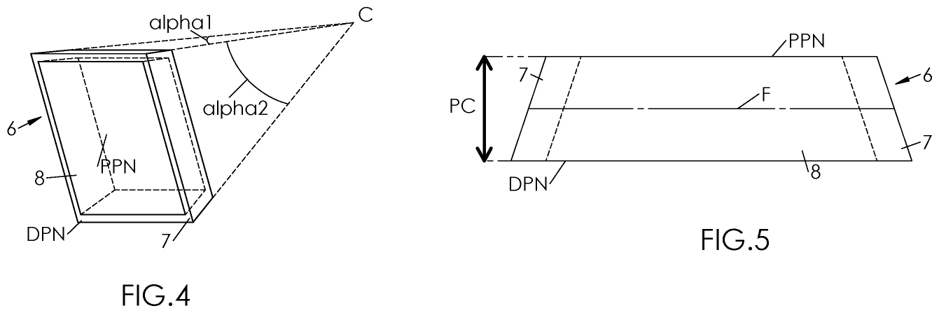

FIG. 4 is a perspective view of an exemplary volume of sharpness.

FIG. 5 is a side view of the exemplary volume of sharpness in FIG. 4.

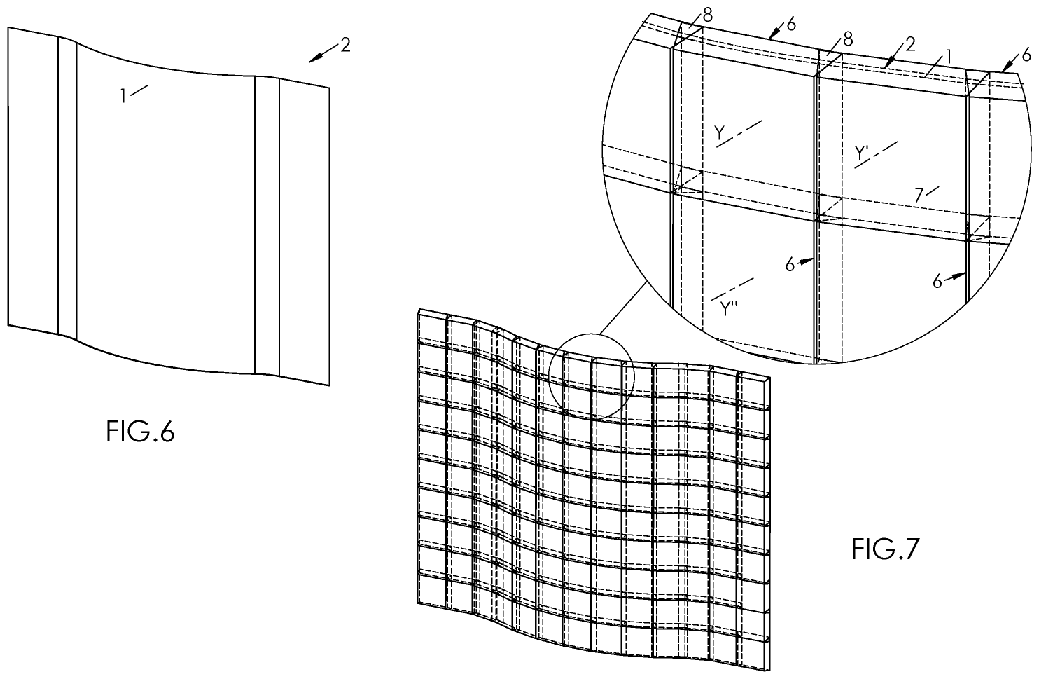

FIG. 6 is a perspective view of an example of a surface to be controlled.

FIG. 7 is an illustration of the surface of FIG. 7 after the paving operation.

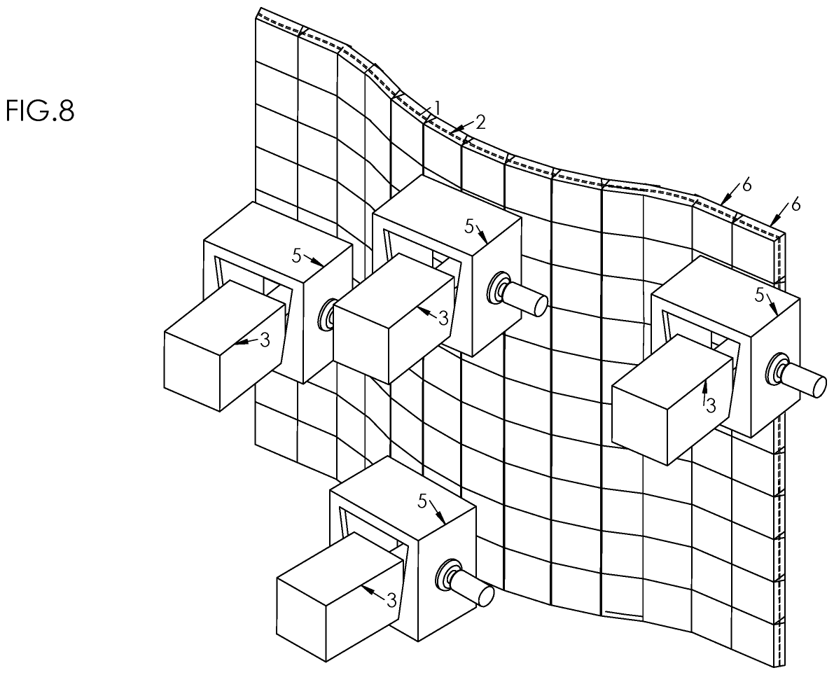

FIG. 8 is an illustration of the camera positioning for each position of a unit model of the three-dimensional virtual model of the sharpness volume.

FIG. 9 illustrates an example of positioning a unit model of the three-dimensional virtual model of the volume of sharpness relative to a surface as a function of distance.

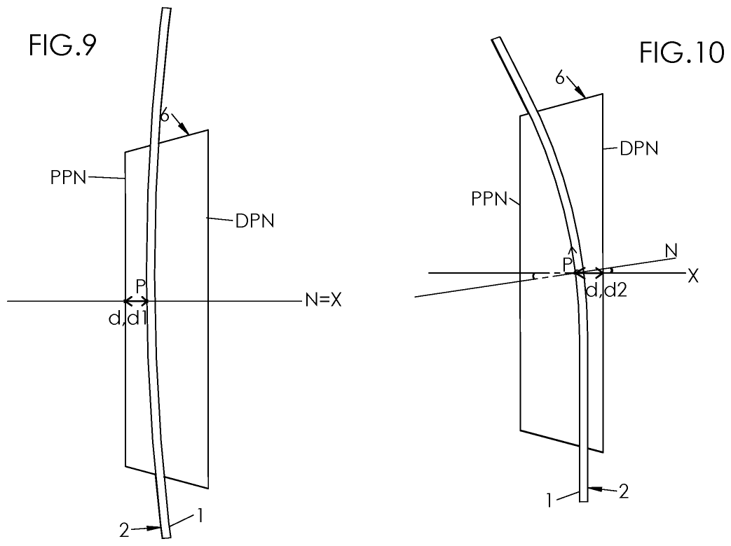

FIG. 10 illustrates an example of positioning a unit model of the three-dimensional virtual model of the volume of sharpness relative to a surface as a function of angle.

The present invention relates to a method for controlling a surface 1 of interest of a part 2 by means of a camera 3 mounted on a carrier robot 4. The mounting of the camera 3 on the carrier robot 4 can for example be carried out using tooling 5 as shown in FIG. 1.

The part 2 can for example be a mechanical part.

The camera 3 comprises a sensor and optics associated with an optical centre C, an angular aperture and a depth of field PC and defining a sharpness volume 6, as shown in FIG. 3.

The method includes the steps of:
loading, in a virtual design environment (e.g. a virtual computer-aided drafting environment), a three-dimensional virtual model of the surface 1 of interest, as illustrated in FIG. 6,
generating, in the virtual environment, of a three-dimensional virtual model of sharpness volume 6, as illustrated in FIG. 2,
paving, in the virtual environment, the model of area 1 of interest by means of a plurality of unit models of said three-dimensional virtual model of sharpness volume 6, as illustrated in FIG. 7,
for each position of said unit models of the three-dimensional virtual model of the volume of sharpness 6, calculating the corresponding position, known as the acquisition position, of the camera 3.

For each position of said unit models, it is then possible to automatically calculate passage points for the robot, and consequently a predefined trajectory allowing it to successively move the camera at the acquisition points.

For each position of a unit model of the three-dimensional virtual model of the sharpness volume 6, the position of the optical axis of the corresponding camera 3 differs. Three optical axes, Y, Y′ and Y″ are shown as examples in FIG. 7. They are not necessarily parallel to each other because the unit models are not necessarily oriented in the same way with respect to the surface 1.

According to a preferred embodiment, the generation of the three-dimensional virtual model of sharpness volume 6 includes the operations of:
loading, a three-dimensional model of the camera 3,
generating a truncated pyramid of which:
   the top is the optical center C of the camera 3,
   the angular aperture is that of the optics, noted alpha,
   two opposite sides define a first sharp plane PPN and a last sharp plane DPN, respectively, whose spacing corresponds to the depth of field PC of the optics.

FIG. 3 can be referred to to identify the positions of the first sharp plane NPP and last sharp plane DPN of the volume of sharpness 6. The planes PPN and DPN are located on either side of a plane L (called the focusing plane) by a focusing distance. This operation allows the geometric characteristics of the camera 3 to be imported into the virtual environment. The use of a truncated pyramid makes it easy to integrate the positions of the first sharp plane PPN and last sharp plane DPN, and the angular aperture of the optics. The angular aperture is represented in FIG. 4 by a pyramidal cone with a rectangular cross-section, on which two angles noted alpha1 and alpha2 can be defined, the angle alpha1 being defined by a first triangle comprising an edge of the rectangular cross-section and the optical centre C, the angle alpha2 being defined by a second triangle adjacent to the first triangle and comprising an edge of the rectangular cross-section and the optical centre C.

According to a special feature, the surface 1 is located, during paving, between the first sharp plane PPN and the last sharp plane DPN of each unit model of the three-dimensional virtual model of the sharpness volume 6, as shown in FIG. 9 and FIG. 10. This configuration ensures that for each corresponding acquisition position of each unit model of the three-dimensional virtual model of the sharpness volume 6, a sharp image is generated by the camera 3.

The geometric characteristics of the camera 3 are supplier data. These include:
the dimensions in pixels of an image provided by the camera 3: the number nₕ of horizontal pixels, the number nᵥ of vertical pixels,
the distance p between the centers of two adjacent pixels on the sensor,
the focusing distance I,
the angular aperture of the optics.

The focusing distance I is user-defined. The geometry of the sharpness volume 6 can be adjusted by a calculation making it possible to manage overlapping areas 7.

Each position of a unit model of the three-dimensional virtual model of sharpness volume 6 on the surface 1 corresponds to a shooting position.

Thus, in the course of this operation, the generation of the three-dimensional virtual model of the sharpness volume 6 may additionally include an operation of dividing the three-dimensional virtual model of the sharpness volume 6 into a working area 8 strictly included therein, and an overlapping peripheral area 7 surrounding the working area 8. An example of a sharpness volume 6 divided into a working area 8 and an overlapping area 7 is shown in FIG. 4 and FIG. 5. Note that this is an example and that the overlapping areas may have a different geometry and dimensions than those shown in FIG. 4 and FIG. 5.

The geometry and dimensions of the working area 8 are governed by the geometry of the generated sharpness volume 6 and a parameter for the desired percentage of overlapping in each image. This parameter can be modulated by an operator. This dividing step makes it easy to manage the desired level of overlapping between two acquisitions.

For each type of sensor, equations are used to calculate the dimensions of the working area 8.

As an example, the following equations are given for applications in the visible range and in particular when using silver sensors.

The calculation of the working area at a focusing distance I is governed by the equations (1) and (2), which calculate the horizontal field of view (HFOV) and the vertical field of view (VFOV) in millimetres, respectively:

$$\begin{matrix}H F O V = \frac{{l}_{h}}{f} . l avec {l}_{h} =. {n}_{h} . p & ( 1 ) \\ V F O V = \frac{{l}_{v}}{f} . l avec {l}_{v} = {n}_{v} . p & ( 2 )\end{matrix}$$

nₕ being the number of horizontal pixels, nᵥ the number of vertical pixels and p the distance between the centers of two adjacent pixels on the acquired images.

The depth of field PC is the difference between the distance from C to the last sharp plane DPN, noted [C, DPN], and the distance from C to the first sharp plane PPN, noted [C,PPN], as shown in equation (3):

PC=[C,DPN]−[C,PPN] (3)

The equations for determining distances [C,DPN] and [C,PPN] vary depending on the sensor. For example, for a silver film camera, these distances are calculated by the equations (4) and (5) where D is the diagonal of the sensor calculated by the equation (6), c is the perimeter of the circle of confusion defined by the equation (7), and H is the hyperfocal distance:

$$\begin{matrix}[ C , DPN ] = \frac{H . l}{H - l} & ( 4 ) \\ [ C , PPN ] = \frac{H . l}{H + l} & ( 5 ) \\ D = \sqrt{{( {n}_{h} . p )}^{2} + {( {n}_{v} . p )}^{2}} & ( 6 ) \\ c = \frac{D}{1730} & ( 7 ) \\ H = \frac{{f}^{2}}{N . c} & ( 8 )\end{matrix}$$

The variables calculated by the equations (4) to (8) may vary depending on the type of sensor used. They are given here as an example.

In the case where the operator has selected a non-zero overlap percentage, the positions of the sharpness volume 6 are set to overlap two by two in the overlap areas 7 during the paving operation of the surface 1. An example of overlapping between the sharpness volumes 6 is shown in FIG. 7.

The use of a sharpness volume allows a control of the viewing area and facilitates the integration of certain constraints such as the distance between the camera 3 and the surface 1, the normality to the surface, the centering on a particular point of the surface 1, the control of the working area 8 and the overlapping area 7.

According to a particular feature, the position of each unit model of the three-dimensional virtual model of the sharpness volume 6 is defined at least by a distance d which can be the distance d1 between a singular point P of the three-dimensional model of the surface 1 of interest and its orthogonal projection on the plane PPN, as shown in FIG. 9. This distance may also be the distance d2 between this point P and its orthogonal projection on the last plane DPN as shown in FIG. 10. According to one exemplary embodiment, in the paving operation, the position of each unit model of the three-dimensional virtual model of sharpness volume 6 can also be defined by the angle between an X axis associated with the three-dimensional virtual model of sharpness volume 6 and the normal N to the surface 1 of interest at the point of intersection of the X-axis and the surface 1. This is illustrated in FIG. 10. In the particular case of FIG. 9, this angle is zero because the normal N is confused with the X axis. The X axis can for example be an axis of symmetry of the virtual three-dimensional model of the sharpness volume, as shown in FIG. 9 and FIG. 10. As a matter of fact, it is essential to know this angular orientation because the position and orientation of the robot is given relative to the part reference.

1.-8. (canceled)

9. A method for controlling a surface of interest of a part by means of a camera intended to be mounted on a carrying robot, the camera comprising a sensor and optics associated with an optical centre (C), with an angular aperture alpha and with a depth of field (PC) and defining a sharpness volume, the method comprising the following operations:
a) loading, in a virtual design environment, a three-dimensional virtual model of the surface of interest,
b) generating, in the virtual environment, a three-dimensional virtual model of the sharpness volume,
c) paving, in the virtual environment, the model of the surface of interest by means of a plurality of unit models of said three-dimensional virtual model of the sharpness volume,
d) for each position of said unit models, calculating the corresponding position, called the acquisition position, of the camera.

10. The method according to claim 9, wherein the generation of the three-dimensional virtual model of the sharpness volume comprises the operations of:
loading, in the virtual environment, a three-dimensional model of the camera and its tooling,
generating a truncated pyramid of which:
the top is the optical centre (C),
the angular aperture is that of the optics noted alpha,
two opposing faces each define a first sharp plane (PPN) and a last sharp plane(DPN), the spacing of which corresponds to the depth of field (PC) of the optics.

11. A method according to claim 10, wherein the surface is located between the first sharp plane (PPN) and the last sharp plane (DPN) of each unit model sharpness volume model.

12. A method according to claim 10, in which the generation of the three-dimensional virtual model of the sharpness volume comprises an operation of dividing the sharpness volume model into a working area strictly included therein, and a peripheral overlapping area surrounding the working area; and in that in the paving operation, the unit models of the sharpness volume model are distributed so as to overlap two by two in said peripheral areas.

13. A method according to claim 11, in which the generation of the three-dimensional virtual model of the sharpness volume comprises an operation of dividing the sharpness volume model into a working area strictly included therein, and a peripheral overlapping area surrounding the working area; and in that in the paving operation, the unit models of the sharpness volume model are distributed so as to overlap two by two in said peripheral areas.

14. A method according to claim 9, wherein in the paving operation, the position of each unit model of the three-dimensional virtual model of volume of sharpness is defined at least by the distance d between a singular point P of the three-dimensional model of the surface of interest and its orthogonal projection on one of the planes (PPN) or (DPN).

15. A method according to claim 10, wherein in the paving operation, the position of each unit model of the three-dimensional virtual model of volume of sharpness is defined at least by the distance d between a singular point P of the three-dimensional model of the surface of interest and its orthogonal projection on one of the planes (PPN) or (DPN).

16. A method according to claim 11, wherein in the paving operation, the position of each unit model of the three-dimensional virtual model of volume of sharpness is defined at least by the distance d between a singular point P of the three-dimensional model of the surface of interest and its orthogonal projection on one of the planes (PPN) or (DPN).

17. A method according to claim 12, wherein in the paving operation, the position of each unit model of the three-dimensional virtual model of volume of sharpness is defined at least by the distance d between a singular point P of the three-dimensional model of the surface of interest and its orthogonal projection on one of the planes (PPN) or (DPN).

18. A method according to claim 14, wherein the singular point P is the barycenter of the three-dimensional virtual model of volume of sharpness.

19. A method according to claim 9, wherein in the paving operation, the position of each unitary sharpness volume model is defined by the angle between an X-axis associated with the sharpness volume model and the normal N to the surface of interest at the point of intersection of the X-axis and the surface.

20. A method according to claim 10, wherein in the paving operation, the position of each unitary sharpness volume model is defined by the angle between an X-axis associated with the sharpness volume model and the normal N to the surface of interest at the point of intersection of the X-axis and the surface.

21. A method according to claim 11, wherein in the paving operation, the position of each unitary sharpness volume model is defined by the angle between an X-axis associated with the sharpness volume model and the normal N to the surface of interest at the point of intersection of the X-axis and the surface.

22. A method according to claim 12, wherein in the paving operation, the position of each unitary sharpness volume model is defined by the angle between an X-axis associated with the sharpness volume model and the normal N to the surface of interest at the point of intersection of the X-axis and the surface.

23. A method according to claim 14, wherein in the paving operation, the position of each unitary sharpness volume model is defined by the angle between an X-axis associated with the sharpness volume model and the normal N to the surface of interest at the point of intersection of the X-axis and the surface.

24. A method according to claim 19, wherein the X-axis is an axis of symmetry of the sharpness volume model.
